(19) United States
(12) Patent Application Publication
(10) Pub. No.: US 2024/0192508 A1
(43) Pub. Date: Jun. 13, 2024

(54) Device Alignment Systems

(71) Applicant: Apple Inc., Cupertino, CA (US)

(72) Inventors: Chih Jen Chen, San Jose, CA (US); Brian S. Lau, Seattle, WA (US); Christopher Patton, San Jose, CA (US)

(21) Appl. No.: 18/444,945

(22) Filed: Feb. 19, 2024

Related U.S. Application Data
(63) Continuation of application No. PCT/US2022/043217, filed on Sep. 12, 2022.
(60) Provisional application No. 63/246,452, filed on Sep. 21, 2021.

(51) Int. Cl. G02B 27/01

(52) U.S. Cl. CPC G02B 27/0176; G02B 27/0172; G02B 2027/0154; G02B 2027/0178

(57) ABSTRACT

A head-mounted device may have display projectors that provide images. Waveguides may be used in conveying the images to eye boxes. Optical couplers such as prisms may be used to couple the images from the projectors into the waveguides. The waveguides may guide the images to output couplers that couple the images toward eye boxes for viewing by a user. During operation of the head-mounted device, sensor circuitry may be used to measure for potential misalignment between optical components such as projectors, couplers, and waveguides. Control circuitry may provide control commands to zero hold power piezoelectric actuators or other positioners based on the sensor measurements, thereby tilting and otherwise repositioning the optical components relative to each other to correct for optical component misalignment.

This application is a continuation of international patent application No. PCT/US2022/043217, filed Sep. 12, 2022, which claims priority to U.S. provisional patent application No. 63/246,452, filed Sep. 21, 2021, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have optical components that are used to provide images to eye boxes for viewing by a user. The optical components, which may sometimes be referred to as optics or optical parts, may include display projectors that produce images. The head-mounted device may have a glasses frame and/or other head-mounted support structures to support the optical components.

The optical components in the head-mounted device may include waveguides and optical couplers. The waveguides may be used in conveying the images from the projectors to the eye boxes. Optical couplers such as prisms may be used to couple images from the projectors into the waveguides. The waveguides may guide the images to output couplers that couple the images toward the eye boxes for viewing by a user.

During operation of the head-mounted device, sensor circuitry may be used to measure for potential misalignment between the optical components that could lead to unwanted image distortion. Control circuitry may provide control commands to zero hold power piezoelectric actuators or other positioners based on the sensor measurements, thereby tilting and otherwise repositioning the optical components relative to each other to correct for optical component misalignment.

### BRIEF DESCRIPTION OF THE DRAWINGS

FIG. 1 is a schematic diagram of an illustrative electronic device such as a head-mounted device in accordance with an embodiment.

FIG. 2 is a top view of an illustrative head-mounted device in accordance with an embodiment.

FIGS. 3 and 4 are side views of illustrative head-mounted device optical component alignment systems in accordance with embodiments.

FIG. 5 is a graph showing how a component alignment system may have zero hold power actuators that consume power only when making adjustments to component positions in accordance with an embodiment.

FIGS. 6, 7, and 8 are top views of illustrative head-mounted device component alignment systems in accordance with embodiments.

### DETAILED DESCRIPTION

Electronic devices such as head-mounted devices may include displays for presenting content to users. The displays may be projectors. A head-mounted device may have a left projector that produces a left image and a right projector that produces a right image. Optical systems (sometimes referred to as optical assemblies) such as systems based on optical prisms, waveguides and/or other optical components (sometimes referred to as optics or optical parts) may be used to convey the left and right images from the projectors to corresponding left and right eye boxes where the images may be viewed by a user. To compensate for potential misalignment between the projectors, waveguides, and optical components such as prisms, a head-mounted device may be provided with alignment systems (sometimes referred to as aligners, alignment circuitry, or positioners). The alignment systems may use low-power actuators to adjust the positions of components in the head-mounted device and thereby ensure that images are provided satisfactorily to the left and right eye boxes.

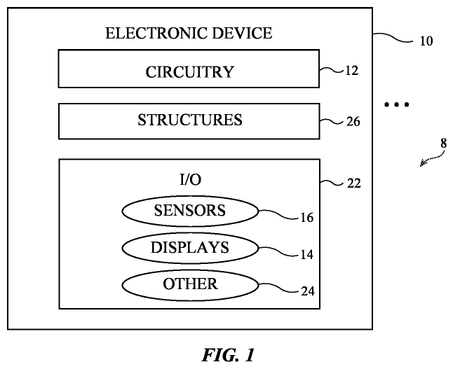

A schematic diagram of an illustrative system that may include a head-mounted device is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video data, audio data, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22 (sometimes referred to as input-output circuitry or input-output). Input-output devices 22 may be used to allow a user to provide device 10 with user input (e.g., input-output devices 22 may have input sensors with which a user provides device 10 with input). Input-output devices 22 may also be used to gather information on the environment in which device 10 is operating (e.g., using sensors). Output components in devices 22 may allow device 10 to provide a user with output and may be used to communicate with external electrical equipment.

As shown in FIG. 1, input-output devices 22 may include one or more displays such as displays 14. In some configurations, device 10 includes left and right display devices. These devices may include left and right components such as left and right image projectors based on scanning mirror display devices, digital mirror devices, liquid-crystal-on-silicon display devices, and/or other reflective display devices, left and right display panels based on light-emitting diode pixel arrays such as organic light-emitting display panels or display devices based on pixel arrays formed from crystalline semiconductor light-emitting diode dies, liquid crystal display panels, and/or or other left and right display devices that provide images to left and right eye boxes for viewing by the user's left and right eyes, respectively. Illustrative configurations in which device 10 has left and right display devices such as left and right projectors (projector displays) that provide respective left and right images for a user's left and right eyes may sometimes be described herein as an example.

Displays 14 are used to display visual content for a user of device 10. The content that is presented on displays 14 may include virtual objects and other content that is provided to displays 14 by control circuitry 12. This virtual content may sometimes be referred to as computer-generated content. Computer-generated content may be combined with real-world content by using an optical coupling system that allows computer-generated content to be optically overlaid on top of a real-world image. As an example, device 10 may have a see-through display system that provides a computer-generated image to a user through a beam splitter, prism, holographic coupler, diffraction grating, or other optical coupler (e.g., an output coupler on a waveguide that is being used to provide computer-generated images to the user) while allowing the user to view real-world objects through the optical coupler and other transparent structures (e.g., transparent waveguide structures, vision-correction lenses and/or other lenses, etc.).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), and/or other sensors.

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components. Actuators in devices 22 may be used to adjust the positions of components in device 10. For example, actuators may be used to adjust the angular orientation of display projectors, optical coupling components such as prims, and waveguides.

Electronic device 10 may have housing structures (e.g., housing walls, straps, etc.), as shown by illustrative support structures 26 of FIG. 1. In configurations in which electronic device 10 is a head-mounted device (e.g., a pair of glasses, goggles, a helmet, a hat, etc.), support structures 26 may include a head-mounted support structure (e.g., a helmet housing, head straps, temples in a pair of eyeglasses, goggle housing structures, and/or other head-mounted structures). Head-mounted support structures, which may sometimes be referred to as a head-mounted support, may be configured to be worn on a head of a user during operation of device 10 and may support displays 14, sensors 16, other components 24, other input-output devices 22, and control circuitry 12.

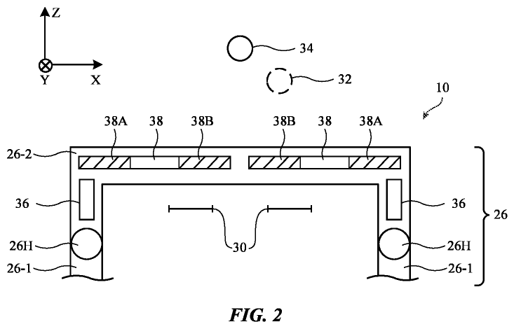

FIG. 2 is a top view of electronic device 10 in an illustrative configuration in which electronic device 10 is a head-mounted device. As shown in FIG. 2, electronic device 10 may include head-mounted support structure 26 to house the components of device 10 and to support device 10 on a user's head. Support structure 26 may include, for example, structures that form housing walls and other structures at the front of device 10 (e.g., support structures 26-2, which may form glasses frame structures such as a nose bridge, end pieces, and/or other housing structures) and additional structures such as straps, temples, or other supplemental support structures (e.g., support structures 26-1) that help to hold the main unit and the components in the main unit on a user's face so that the user's eyes are located within eye boxes 30. If desired, support structure 26 may include hinges such as hinges 26H. Support structures 26-1 may be coupled to support structures 26-2 using hinges 26H (e.g., so that the temples or other structures in device 10 can be folded parallel to the frame at the front of device 10 when not in use).

During operation of device 10, images are presented to a user's eyes in eye boxes 30 from projectors 36 using waveguides 38. Waveguides 38 are transparent, so that a user with eyes located in eye boxes 30 may view real-world objects such as objects 34 through waveguides 38 while simultaneously viewing overlaid computer-generated (virtual) images such as virtual image 32.

Eye boxes 30 include a left eye box that receives a left image and a right eye box that receives a right image. Device 10 may include a left display system that presents the left image to the left eye box and a right display system that presents the right image to the right eye box. In an illustrative configuration, each display system has a corresponding projector 36, a waveguide 38, and an optical coupler (e.g., a prism and/or other optical coupling element(s)) to couple an image from the projector into the waveguide from the projector. An output coupler on each waveguide may be used to couple the image out of that waveguide towards a respective eye box after the waveguide has guided the image to a location overlapping the eye box.

In the illustrative configuration of FIG. 2, a left projector 36 may produce a left image and a right projector 36 may produce a right image. Left and right waveguides 38 at the front of device 10 may be provided with left and right optical input couplers 38A that respectively receive the left and right images and couple those images into the left and right waveguides. Waveguides 38 then convey the received images laterally towards the center of device 10 in accordance with the principal of total internal reflection. The left and right images are coupled out of the waveguides towards eye boxes 30 using output couplers 38B (e.g., gratings, holographic output couplers, or other suitable output couplers).

During use of device 10, device 10 may be subjected to excessive stress (e.g., during drop events or other events in which more force than desired is applied to structures 26 and other portions of device 10). This may lead to a potential for optical components (sometimes referred to as optics or optical parts) in device 10 to become misaligned. As one example, projectors 36 may become angularly misaligned relative to waveguides 38 and prisms in device 10. In some scenarios, optical component misalignment (sometimes referred to as optical part misalignment or optics misalignment) may occur due to deformation of structures 26 as device 10 is being worn on a user's head.

To compensate for optical component movements, the relative angular orientation of components (structures) in device 10 (e.g., the orientation of parts such as projectors, prisms, waveguides or other optics, housing structures, etc.) can be monitored using sensor circuitry (e.g., one or more sensors 16) to detect optical misalignment. As an example, a nose bridge strain gauge sensor may be used to determine when some or all of the housing of device 10 and the components in device 10 exhibits misalignment (e.g., misalignment as the left and right sides of device 10 bend about the X axis of FIG. 2, sometimes referred to as changes in pitch), as device 10 deforms about the Y axis of FIG. 2 (sometimes referred to as changes in yaw), and/or as device 10 deforms about the Z axis of FIG. 2 (sometimes referred to as roll).

Optical sensors, inertial measurement units, or other sensor devices that measure changes in angular orientation (and, if desired, changes in lateral position) of optical components in device 10 may make real time optical misalignment measurements (e.g., angular orientation measurements, etc.) that reveal optical misalignment of the optics in device 10. Control circuitry 12 can use this optical component orientation information to control actuators in device 10. The actuators may be used to reposition any misaligned components and thereby compensate for measured misalignment (e.g., by measuring optical misalignment, the positioners in device 10 can correct the optical misalignment). As an example, control circuitry 12 may use sensor circuitry to detect that the left projector in device 10 has become angularly misaligned by 0.5° relative to the left waveguide in device 10. Based on this measurement, the position (e.g., angular orientation) of the left projector and/or the left waveguide may be adjusted so that the left projector and left waveguide are aligned as desired. In this way, image distortion (e.g., keystoning, image rotation, etc.) that might otherwise arise when components become misaligned can be avoided.

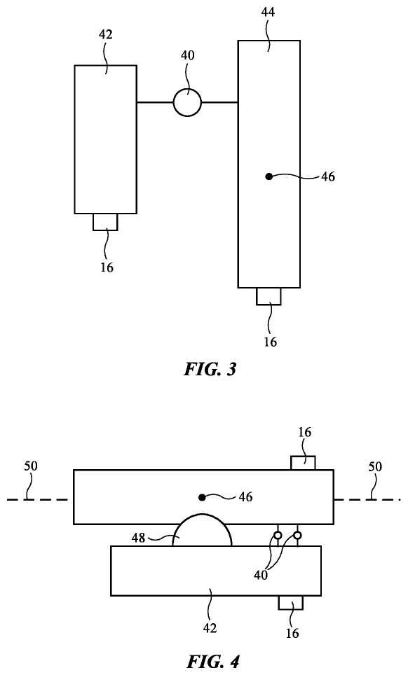

FIGS. 3 and 4 are side views of illustrative positioning systems that may be used in adjusting the positions of structures in device 10 to avoid component misalignment and associated image distortion. In general, the positioning systems in device 10 may use any suitable positioners (e.g., piezoelectric actuators, stepper motors, electromagnetic actuators, etc.) and may use these positions to make any suitable translational movements and/or rotational movements of the optical components in device 10. In the example of FIG. 3, a single actuator 40 is coupled between items 42 and 44. Item 44 is mounted for rotation within device 10 about axis 46. Item 42 and item 44 may each be a housing structure (e.g., a part of structure 26), all or part of a display such as projector 36 of FIG. 2, all or part of a prism (prism module) or other optical coupler for coupling images into a waveguide, a waveguide, and/or other optical component or housing structure. As an example, item 42 may be a housing structure or a first optical component and item 44 may be a second optical component. By controlling actuator 40, item 44 may be rotated (e.g., tilted) about axis 46 and the angular orientation of item 44 relative to item 42 may therefore be adjusted. In this way, the angular orientation between the display system optical components in device 10 can be adjusted to compensate for misalignment.

As shown in FIG. 3, sensor circuitry based on one or more sensors 16 may be used to measure the position (e.g., the angular orientation, etc.) of item 42 and/or item 44. Sensors 16 may include strain gauges sensors for measuring bending in a glasses frame and/or other structures in device 10, may include angular orientation sensors that are attached to item 44 and/or item 44 (and/or that are attached to nearby portions of structures 26), may include optical sensors, may include capacitive sensors, may include force sensors, and/or may include other sensors that measure the angular orientation and/or that gather other position data on items such as items 42 and 44. Sensors 16 may provide angular orientation information and/or other position information as an output in real time and this output may be received and processed by control circuitry 12. Control circuitry 12 may, in response to detected misalignment, issue control commands (e.g., control voltages and/or currents, digital control commands, etc.) that cause actuators 40 to make corresponding position adjustments to items 42 and/or 44 to correct for the misalignment. Control circuitry 12 may measure misalignment and may adjust actuators 40 to compensate for the measured misalignment continuously, periodically (e.g., once per minute or other suitable time period), in response to detecting excessive force on device 10 (e.g., by using an accelerometer or other sensor to detect when device 10 has been dropped or otherwise subjected to unexpectedly large forces of the type that could create optical component misalignment), in response to user input, when device 10 is powered up, and/or in response to satisfaction of other suitable calibration criteria.

In the example of FIG. 3, component orientation is being adjusted about a single axis (axis 46). If desired, components may be mounted on gimble supports or other support structures that allow component orientation to be adjusted (e.g., tilted) about multiple axes (e.g., first and second orthogonal axes). Consider, as an example, the arrangement of FIG. 4. In the arrangement of FIG. 4, item 44 is mounted on hemispherical pivot 48. This allows item 44 to be rotated (tilted) in two orthogonal dimensions (e.g., using first and second actuators 40 of FIG. 4). For example, a first of actuators 40 may be configured to rotate (tilt) item 44 about axis 46 relative to item 42 and a second of actuators 40 may be configured to rotate (tilt) item 44 about axis 50 relative to item 42.

To conserve battery power (e.g., when device 10 is running solely on a battery), it may be desirable to minimize power consumption by actuators 40. This may be accomplished by using actuators that do not consume power unless actively being used to reposition components. These actuators may sometimes be referred to as zero holding power actuators, because no power is consumed when components are held in position, only when the actuators are being adjusted to reposition components. Examples of zero holding power actuators that may be sued in device 10 include motor-driven lead screw actuators, stepper motors, and zero holding power piezoelectric actuators. Zero holding power piezoelectric actuators, which may sometimes be described herein as an example, may be light in weight and compact, thereby helping to avoid producing excess weight or size for device 10.

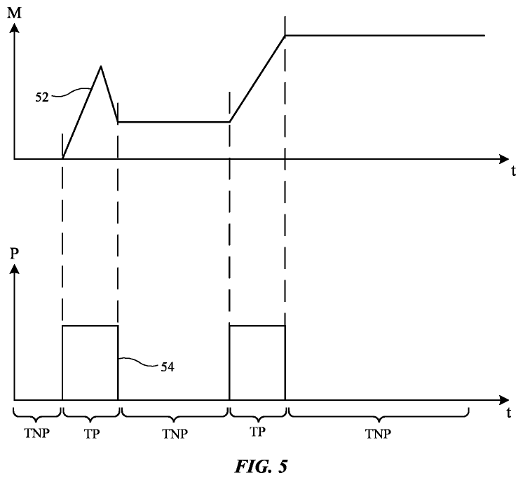

The operation of a zero holding power actuator (no holding power actuator) such as a zero holding power piezoelectric actuator is shown in the graphs of FIG. 5. In the upper portion of FIG. 5, the position M (curve 52) of an item being moved by a zero holding power actuator is plotted as a function of time t. In the lower portion of FIG. 5, the corresponding amount of power P consumed by the actuator (curve 54) is plotted as a function of time t. As this example demonstrates, power P is only consumed during repositioning periods (TP) when the actuator is in active use and is moving a component. No power P is consumed during holding periods TNP. As a result, when infrequent repositioning operations are needed (e.g., during normal operation when the structures of device 10 are relatively stable), only small amounts of power are consumed.

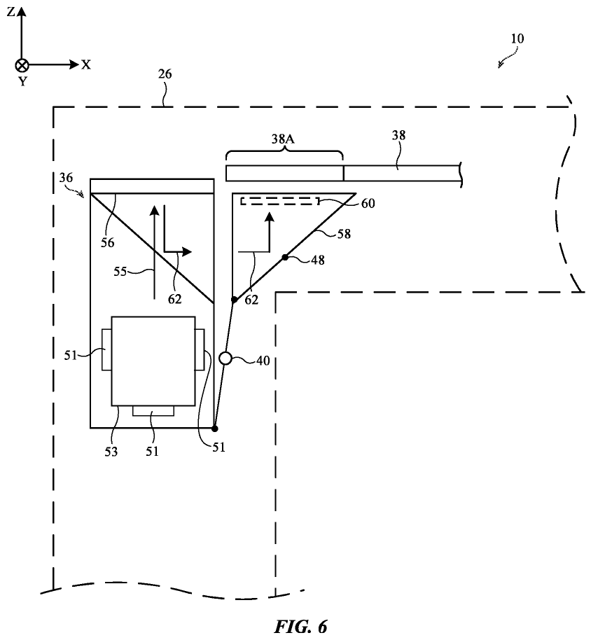

FIG. 6 is a top view of a portion of device 10 in an illustrative configuration in which device 10 includes zero holding power actuators for component alignment. In FIG. 6, the left portion of device 10 is shown. As shown in FIG. 6, projector 36 includes light source 53. Light source 53 may use red, blue, and green light-emitting diodes 51 or other light-emitting components to produce illumination 55 for a reflective display pixel array (e.g., digital mirror device 56). Polarizers, wave plates, and/or other optical components may be incorporated into projector 36, so that illumination 55 reflects from the surface of device 56 as image (image light) 62 and is provided to an optical coupling system. As shown in FIG. 6, image 62 may, for example, be coupled into waveguide 38 using an optical coupling system such as a prism or other optical coupler. The illustrative optical coupler of FIG. 6 includes prism module 58 and input coupler 38A (e.g., a hologram, grating, etc.) on waveguide 38. Other optical coupling systems may be used to couple image 62 into waveguide 38, if desired.

Prism module (prism) 58 may include a prism to reflect image light (image 62) towards waveguide 38 and may, if desired, include optical components such as lenses (sec, e.g., illustrative optical component 60). Prism module 58 may be mounted on a hemispherical pivot or other pivot such as pivot 48 (e.g., a pivot mounted to structures 26). This allow prism module 58 to be tilted in two dimensions. For example, a first of actuators 40 that is coupled between projector 36 and prism module 58 may be used to rotate module 58 about the X axis and a second of actuators 40 that is coupled between projector 36 and prism module 58 may be used to rotate module 58 about the Y axis).

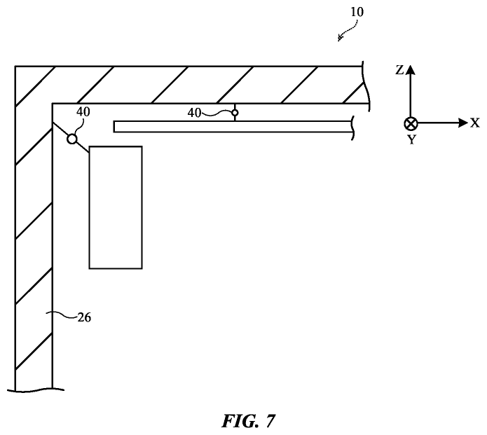

In the example of FIG. 6, the relative orientations between optical components such as projector 36, prism 58, and waveguide 38 can be adjusted using actuators 40 that are coupled between projector 36 and waveguide 38. If desired, actuators 40 may be coupled to structures 26. As shown in FIG. 7, for example, one or more actuators 40 may be coupled between projector 36 and structures 26 (e.g., to tilt projector 36 about one or more axes relative to structures 26) and one or more actuators 40 may be coupled between waveguide 38 and structures 26 (e.g., to tilt projector 36 about one or more axes relative to structures 26). Prism modules may also be adjusted in this way. With this type of arrangement, the relative orientation between projector 36 and waveguide 38 (and, if desired, prism 58) may be controlled by repositioning projector 36, by repositioning waveguide 38, by repositioning both projector 36 and waveguide 38, and/or by adjusting the position of prism 58 using an actuator coupled between prism 58 and structure 26.

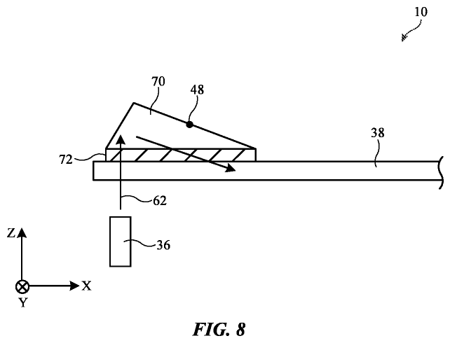

FIG. 8 is a top view of a left portion of device 10 in an illustrative configuration in which a prism for coupling image 62 into waveguide 38 is located on the opposite side of waveguide 38 from projector 36. Refractive index matching fluid 72 (e.g., oil) may be located between the inwardly facing surface of prism 70 and the opposing outwardly facing surface of waveguide 38. The presence of fluid 72 helps reduce light reflections at the surface of prism and at the opposing surface of waveguide 38. At the same time, the liquid nature of fluid 72 accommodates movement (e.g., tilting) of prism 70 about pivot 48 as prism 70 is moved by actuators 40. During operation, projector 36 emits image light (image 62) which passes through waveguide 38 and fluid 72 into prism 70. Image 62 is then reflected out of prim 70 and passes through fluid 72 into waveguide 38, where image 62 is guided along the length of waveguide 38 in accordance with the principal of total internal reflection. As with the illustrative configurations of FIGS. 6 and 7, sensors 16 may be mounted on structures 26, on projectors 36, on prisms or other optical couplers, on waveguides 38, and/or may be placed on separate parts of these components that tilt or otherwise move relative to each other under control of actuators 40. Control circuitry 12 may use sensor measurements from sensor circuitry based on one or more sensors 16 to detect optical component misalignment and may issue corresponding control signals to actuators 40 to correct for any detected misalignment.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

In accordance with an embodiment, a head-mounted device is provided that includes a head-mounted support, a projector supported by the head-mounted support and configured to produce an image, a waveguide supported by the head-mounted support and configured to guide the image, at least one sensor configured to measure optical misalignment of at least one of: the projector or the waveguide, and a positioner configured to adjust based on the measured optical misalignment to correct the optical misalignment.

In accordance with another embodiment, the head-mounted device includes a prism configured to direct the image from the projector to the waveguide, the at least one sensor is configured to measure angular orientation between the projector and the prism, the positioner includes a zero hold power piezoelectric actuator, and the positioner is configured to prevent misalignment-induced distortion to the image by using the zero hold power piezoelectric actuator to adjust the angular orientation between the projector and the prism.

In accordance with another embodiment, the positioner includes a zero holding power actuator.

In accordance with another embodiment, the head-mounted device includes a pivot about which a given one of the projector and the waveguide tilts.

In accordance with another embodiment, the head-mounted device includes a prism.

In accordance with another embodiment, the pivot is configured to allow a given one of the projector, the waveguide, and the prism to tilt about two different axes.

In accordance with another embodiment, the head-mounted device includes a prism.

In accordance with another embodiment, positioner is configured to adjust angular alignment between the projector and the prism.

In accordance with another embodiment, the positioner is configured to adjust angular alignment between the prism and the waveguide.

In accordance with another embodiment, the head-mounted device includes fluid between the prism and the waveguide, the prism is configured to receive the image from the projector after the image has passed through the waveguide.

In accordance with an embodiment, a head-mounted device is provided that includes a head-mounted support, left and right waveguides supported by the head-mounted support, left and right projectors configured to produce respective left and right images, left and right optical couplers configured to couple the left and right images respectively into the left and right waveguides, and zero hold power actuators configured to move the left and right optical couplers relative to the left and right projectors, respectively.

In accordance with another embodiment, the head-mounted device includes at least one sensor configured to measure angular orientations of the left and right projectors relative to the left and right optical couplers, respectively.

In accordance with another embodiment, the zero hold power actuators are configured to tilt the left and right optical couplers relative to the left and right projectors to compensate for misalignment between the left and right optical couplers and the left and right projectors, respectively.

In accordance with another embodiment, the zero hold power actuators include at least one zero hold power actuator coupled to the head-mounted support.

In accordance with another embodiment, the zero hold power actuators include at least one zero hold power actuator coupled to a selected one of the left and right projectors.

In accordance with another embodiment, the left and right optical couplers each include a tiltable prism.

In accordance with an embodiment, a head-mounted device is provided that includes a head-mounted support, a projector, a waveguide, and a prism that are supported by the head-mounted support and that are configured to provide an image to an eye box, and at least one zero hold power piezoelectric actuator configured to adjust optical alignment of the projector, the waveguide, and the prism.

In accordance with another embodiment, at least a given one of the projector, the waveguide, and the prism is tilted about a pivot by the zero hold power piezoelectric actuator.

In accordance with another embodiment, the zero hold power piezoelectric actuator is configured to tilt the projector.

In accordance with another embodiment, the zero hold power piezoelectric actuator is configured to tilt the waveguide.

The foregoing is merely illustrative and various modifications can be made to the described embodiments. The foregoing embodiments may be implemented individually or in any combination.

What is claimed is:

1. A head-mounted device, comprising:
a head-mounted support;
a projector supported by the head-mounted support and configured to produce an image;
a waveguide supported by the head-mounted support and configured to guide the image;
at least one sensor configured to measure optical misalignment of at least one of: the projector or the waveguide; and
a positioner configured to adjust based on the measured optical misalignment to correct the optical misalignment.

2. The head-mounted device defined in claim 1 further comprising a prism configured to direct the image from the projector to the waveguide, wherein the at least one sensor is configured to measure angular orientation between the projector and the prism, wherein the positioner comprises a zero hold power piezoelectric actuator, and wherein the positioner is configured to prevent misalignment-induced distortion to the image by using the zero hold power piezoelectric actuator to adjust the angular orientation between the projector and the prism.

3. The head-mounted device defined in claim 1 wherein the positioner comprises a zero holding power actuator.

4. The head-mounted device defined in claim 3 further comprising a pivot about which a given one of the projector and the waveguide tilts.

5. The head-mounted device defined in claim 4 further comprising a prism.

6. The head-mounted device defined in claim 5 wherein the pivot is configured to allow a given one of the projector, the waveguide, and the prism to tilt about two different axes.

7. The head-mounted device defined in claim 1 further comprising a prism.

8. The head-mounted device defined in claim 7 wherein positioner is configured to adjust angular alignment between the projector and the prism.

9. The head-mounted device defined in claim 7 wherein the positioner is configured to adjust angular alignment between the prism and the waveguide.

10. The head-mounted device defined in claim 9 further comprising fluid between the prism and the waveguide, wherein the prism is configured to receive the image from the projector after the image has passed through the waveguide.

11. A head-mounted device, comprising:
a head-mounted support;
left and right waveguides supported by the head-mounted support;
left and right projectors configured to produce respective left and right images;
left and right optical couplers configured to couple the left and right images respectively into the left and right waveguides; and
zero hold power actuators configured to move the left and right optical couplers relative to the left and right projectors, respectively.

12. The head-mounted device defined in claim 11 further comprising at least one sensor configured to measure angular orientations of the left and right projectors relative to the left and right optical couplers, respectively.

13. The head-mounted device defined in claim 11 wherein the zero hold power actuators are configured to tilt the left and right optical couplers relative to the left and right projectors to compensate for misalignment between the left and right optical couplers and the left and right projectors, respectively.

14. The head-mounted device defined in claim 13 wherein the zero hold power actuators comprise at least one zero hold power actuator coupled to the head-mounted support.

15. The head-mounted device defined in claim 13 wherein the zero hold power actuators comprise at least one zero hold power actuator coupled to a selected one of the left and right projectors.

16. The head-mounted device defined in claim 11 wherein the left and right optical couplers each comprise a tiltable prism.

17. A head-mounted device, comprising:
a head-mounted support;
a projector, a waveguide, and a prism that are supported by the head-mounted support and that are configured to provide an image to an eye box; and
at least one zero hold power piezoelectric actuator configured to adjust optical alignment of the projector, the waveguide, and the prism.

18. The head-mounted device defined in claim 17 wherein at least a given one of the projector, the waveguide, and the prism is tilted about a pivot by the zero hold power piezoelectric actuator.

19. The head-mounted device defined in claim 18 wherein the zero hold power piezoelectric actuator is configured to tilt the projector.

20. The head-mounted device defined in claim 18 wherein the zero hold power piezoelectric actuator is configured to tilt the waveguide.
